(19) United States
(12) Patent Application Publication
(10) Pub. No.: US 2019/0193535 A1
(43) Pub. Date: Jun. 27, 2019

(54) RESIN BACK DOOR FOR VEHICLE

(71) Applicants: TOYOTA JIDOSHA KABUSHIKI KAISHA, Toyota-shi (JP); TOYOTA JIDOSHA KYUSHU KABUSHIKI KAISHA, Miyawaka-shi (JP)

(72) Inventors: Kenji CHIBA, Tokai-shi (JP); Takayuki OKUBO, Toyota-shi (JP); Kiyokazu NITTA, Miyoshi-shi (JP)

(73) Assignees: TOYOTA JIDOSHA KABUSHIKI KAISHA, Toyota-shi (JP); TOYOTA JIDOSHA KYUSHU KABUSHIKI KAISHA, Miyawaka-shi (JP)

(21) Appl. No.: 16/217,832

(22) Filed: Dec. 12, 2018

(30) Foreign Application Priority Data
Dec. 21, 2017 (JP) 2017-245372

(51) Int. Cl. B60J 5/10

(52) U.S. Cl. CPC B60J 5/107

(57) ABSTRACT

When a resin back door closes a door opening, a design surface of an inner vertical wall on the inner side in a vehicle width direction is substantially flush with a design surface of an inner garnish attached to the inner periphery of the door opening.

### CROSS REFERENCE TO RELATED APPLICATION

This application claims priority to Japanese Patent Application No. 2017-245372 filed on Dec. 21, 2017, which is incorporated herein by reference in its entirety including the specification, claims, drawings, and abstract.

### TECHNICAL FIELD

The present disclosure relates to a structure of a resin back door for a vehicle.

### BACKGROUND

Vehicles which include opening portions positioned at rear end portions thereof and that are opened and closed by back doors have been widely used, facilitating access to cargo spaces positioned in back of rear seats of the vehicles.

Furthermore, in recent years, many vehicle doors made of resin have been used. The doors made of resin have a reduced weight but ensuring rigidity is difficult as compared with doors made from steel plate. For this reason, a structure has been proposed to mount a metal reinforcing member in a hollow space defined by a resin inner panel and a resin outer panel (e.g., see JP 5846036 B).

### SUMMARY

Incidentally, in related art, a steel back door 300 as illustrated in FIG. 6 includes a door interior trim 260 being a resin component constituting an interior design surface that is attached on the interior side. The steel back door 300 includes a steel frame 70 formed by a groove-shaped inner panel 71, a hat-shaped outer panel 72, and a groove-shaped reinforcing member 73 which are assembled by welding, and the door interior trim 260 attached to the frame 70 on the interior side of a door opening 78 of a back window 12. The door interior trim 260 is mounted so as to be close to body interior trims 250 and 251 which are attached on the interior side of a body inner panel 216 positioned at a body rear end portion 210 and constitute a design surface. As illustrated in FIG. 6, a gap between the body interior trim 251 and the door interior trim 260 is reduced to s2 so that a water-tight rubber 230 disposed between the steel back door 300 and the body rear end portion 210 is concealed from the interior, improving the appearance of a rear side of the vehicle when viewed from an interior of the vehicle.

In contrast, unlike the steel back door 300, the door interior trim 260 as a separate component does not need to be attached to a resin back door, since a surface on the interior side of a resin inner panel constitutes a design surface. However, as illustrated in FIG. 6, a gap between the body interior trim 251 and the inner panel 71 increases to s3 and the water-tight rubber 230 is sometimes seen from the interior, resulting in poor appearance of a rear side of the vehicle when viewed from an interior of the vehicle.

It is therefore an object of the present disclosure to provide a resin back door which improves the appearance of a rear side of a vehicle when viewed from an interior of the vehicle.

### Solution to Problem

A resin back door according to an embodiment of the present disclosure is a resin back door for a vehicle for opening and closing a door opening at a body rear end portion. The resin back door includes a resin inner panel including a window frame portion for a back window opening positioned on an outer side in a vehicle width direction. In the resin back door, the window frame portion of the inner panel has a substantially groove-shaped cross-section, and includes a bottom portion abutting on a water-tight rubber attached to a peripheral edge of the door opening, and an inner vertical wall positioned on an inner side in a vehicle width direction to be connected to the bottom portion. The bottom portion has a projecting portion projecting toward the door opening at an inner end in a vehicle width direction. When the door opening is closed, a surface of the inner vertical wall on an inner side in a vehicle width direction is substantially flush with an interior trim surface attached to an inner periphery of the door opening.

### Advantageous Effects of Invention

According to an embodiment of the present disclosure, a resin back door for a vehicle improves the appearance of a rear side of a vehicle when viewed from an interior of the vehicle.

### BRIEF DESCRIPTION OF DRAWINGS

Embodiment(s) of the present disclosure will be described by reference to the following figures, wherein:

FIG. 1 is a perspective view of a vehicle to which a resin back door according to an embodiment is attached;

FIG. 2 is a cross-sectional view taken along line A-A (a cross-section of a left side portion of a body rear end portion) of FIG. 1;

FIG. 3 is a perspective view of the resin back door according to an embodiment;

FIG. 4 is an exploded perspective view of a resin back door according to an embodiment;

FIG. 5 is a cross-sectional view of the cross-section taken along line A-A of FIG. 1 (the cross-section of the left side portion of the body rear end portion) and a cross-section taken along line B-B of FIG. 3 (a cross-section of a left window frame portion of the resin back door) when a door opening is closed by the resin back door; and

FIG. 6 is a cross-sectional view of a cross-section of a left side portion of a body rear end portion and a cross-section of a left window frame portion of a steel back door when a door opening is closed by the steel back door according to the related art.

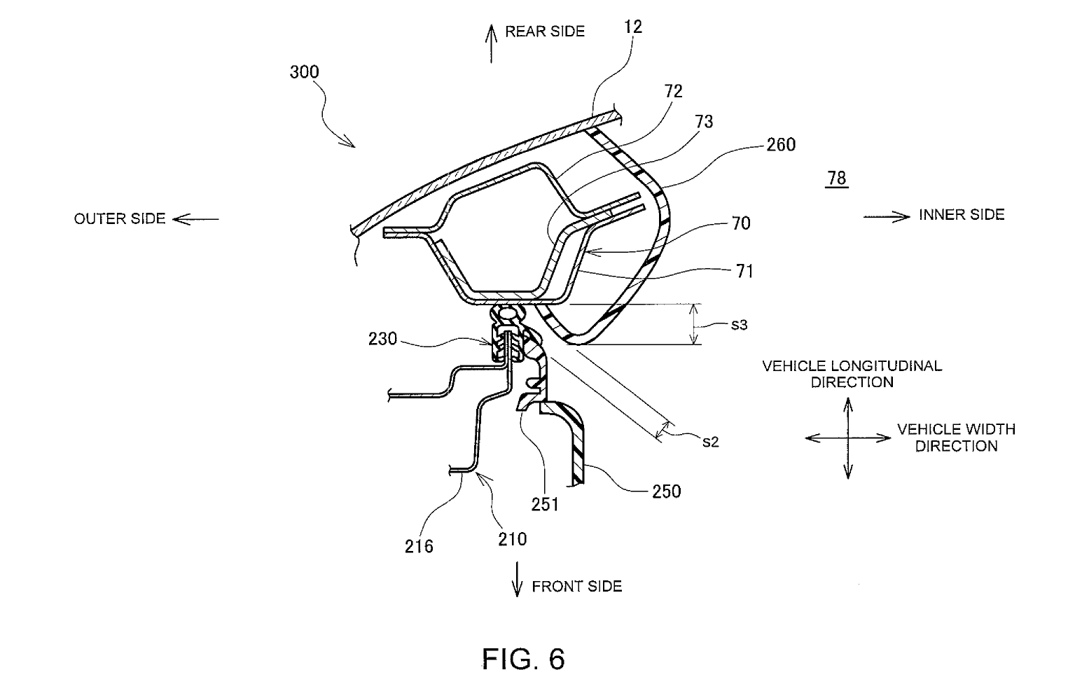

### DESCRIPTION OF EMBODIMENTS

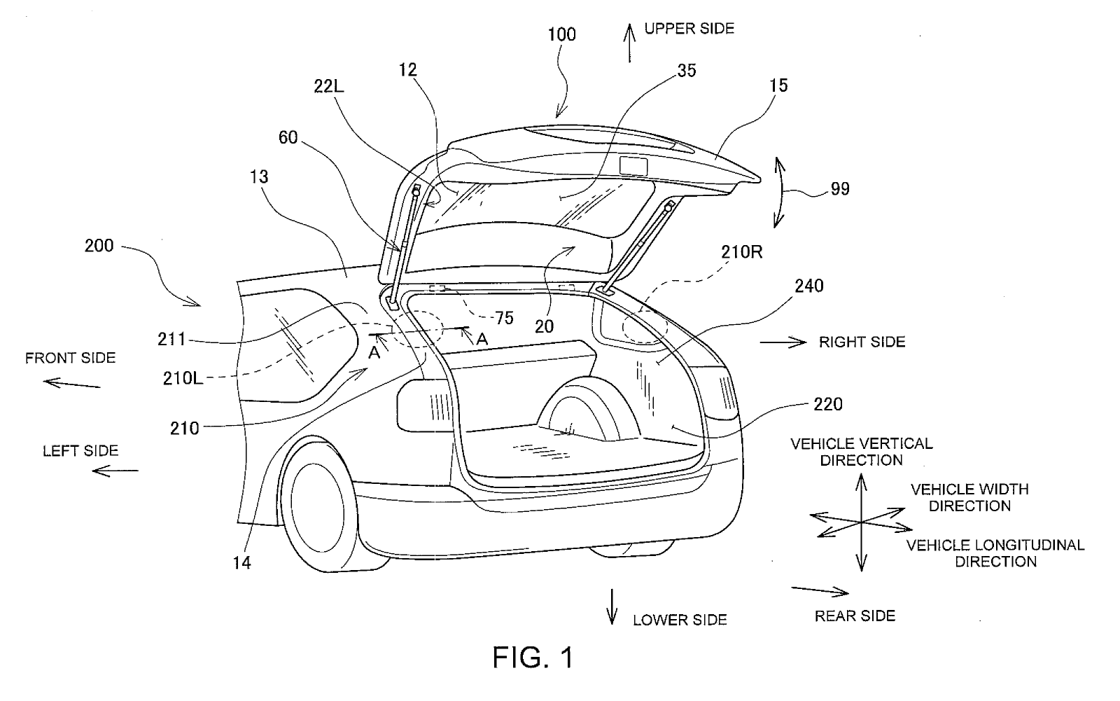

Hereinafter, a resin back door 100 of a vehicle 200 according to the present embodiment will be described with reference to the drawings. As illustrated in FIG. 1, the resin back door 100 is a hatch door turnably attached to a roof panel 13 of a body rear end portion 210 of the vehicle 200 via a pair of right and left hinges 75 provided at an upper end portion of the resin back door 100, and turned vertically about the hinges 75 as indicated by an arrow 99 to open and close a door opening 220 defined in the body rear end portion 210.

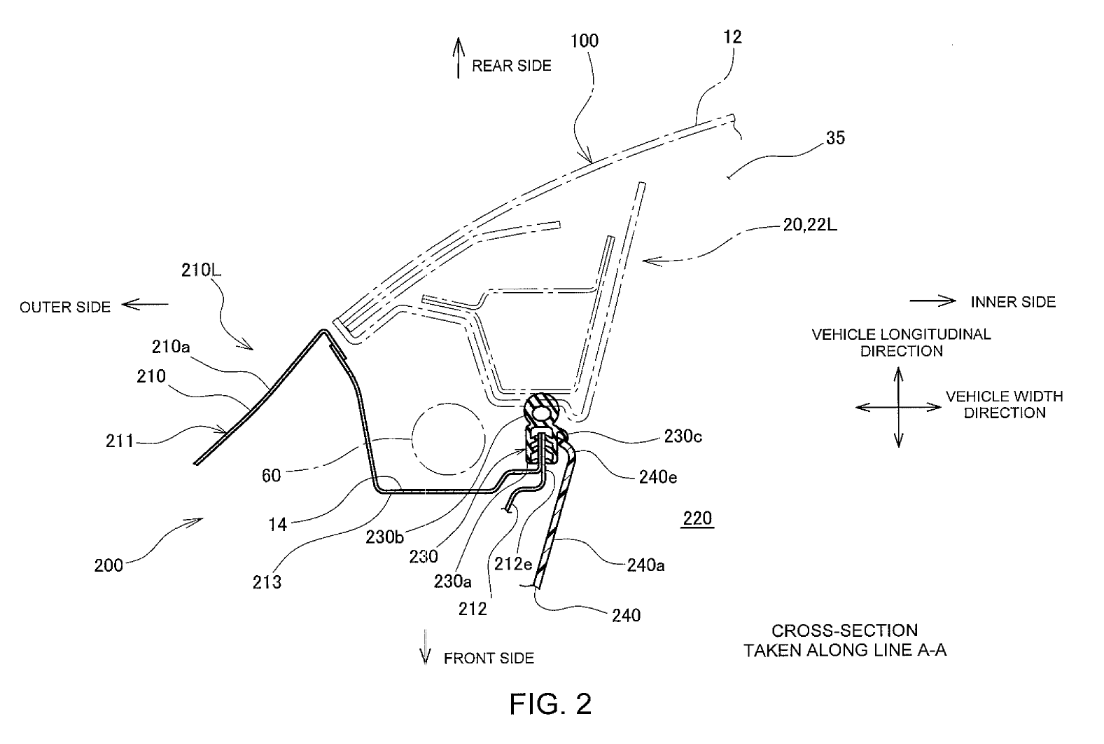

As illustrated in FIG. 2, the body rear end portion 210 has a left side portion 210L including a body outer panel 211, a body inner panel 212, a trough panel 213, a water-tight rubber 230, and an inner garnish 240 as an interior trim. The body outer panel 211 constitutes a design surface 210a positioned on the outside of the body rear end portion 210. The body inner panel 212 is a panel positioned on an interior side. The trough panel 213 is a panel attached between the body outer panel 211 and the body inner panel 212 to constitute a groove-shaped trough 14. As illustrated in FIGS. 1 and 2, between the trough 14 and an inner panel 20 of the resin back door 100, damper stays 60 are mounted to reduce an operation force for opening the resin back door 100 and maintain the opening state. The right side and the left side are described as the right side and the left side as viewed from a rear side of the vehicle.

As illustrated in FIG. 2, the trough panel 213 has an inner end in a vehicle width direction having an L-shaped flange projecting to the rear side of the vehicle or toward the resin back door 100. Furthermore, the body inner panel 212 has a rear end in a vehicle longitudinal direction overlappingly connected to the flange of the trough panel 213 to form a collar portion 212e protruding to the rear side of the vehicle or toward the resin back door 100. The collar portion 212e defines a peripheral edge of the door opening 220. The water-tight rubber 230 is attached to a vehicle-rearward end of the collar portion 212e.

The water-tight rubber 230 is a packing interposed between the collar portion 212e and the inner panel 20 to prevent intrusion of water into the interior from between the resin back door 100 and the body rear end portion 210. The water-tight rubber 230 includes a main body 230a, a packing portion 230b, and a lip 230c. The main body 230a includes a holding lip internally provided to hold the collar portion 212e from both sides. The packing portion 230b, projecting to a vehicle-rearward side of the main body 230a, is held and compressed between the collar portion 212e and the inner panel 20. The lip 230c projects to the inner side in a vehicle width direction from the main body 230a. As illustrated in FIG. 2, the water-tight rubber 230 is configured so that when the main body 230a is attached to the collar portion 212e, the packing portion 230b projects toward the resin back door 100.

The body inner panel 212 has an inner side positioned on an interior side in a vehicle width direction, and the inner garnish 240 is attached on the inner side. The inner garnish 240 is provided on the inner side of the collar portion 212e defining the peripheral edge of the door opening 220, in a vehicle width direction. The inner garnish 240 includes an end portion 240e positioned on the rear side of the vehicle. The end portion 240e is held between the lip 230c of the water-tight rubber 230 and an outer surface of the main body 230a so that the end portion 240e does not move relative to the water-tight rubber 230 and the collar portion 212e. The inner garnish 240 includes a design surface 240a on the inner side in a vehicle width direction or on the interior side to constitute an inner peripheral surface of the door opening 220.

Although the left side portion 210L of the body rear end portion 210 has been described above, a right side portion 210R and the left side portion 210L are symmetrical to each other and have the same configuration.

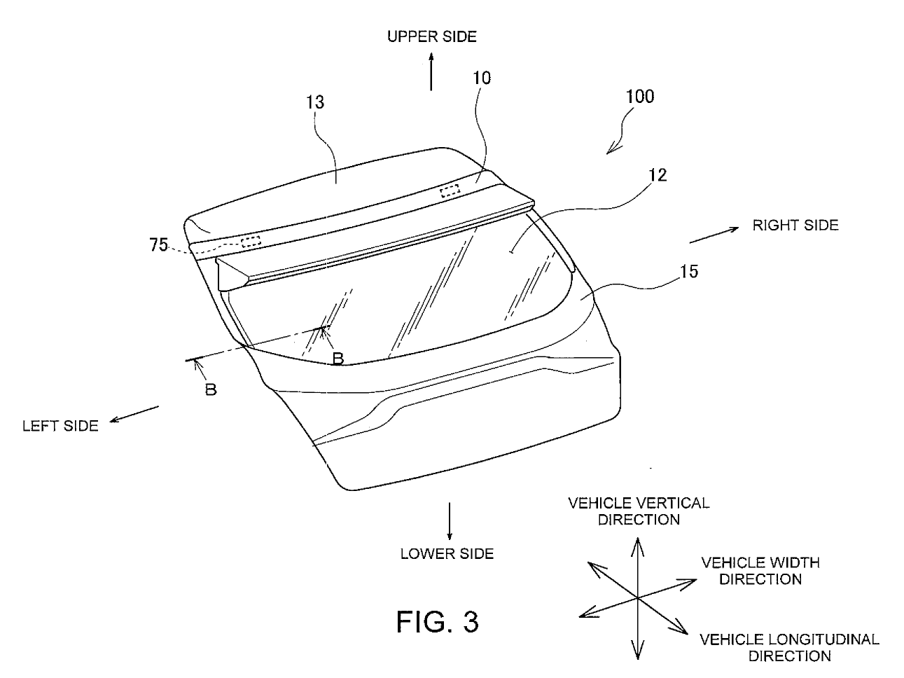

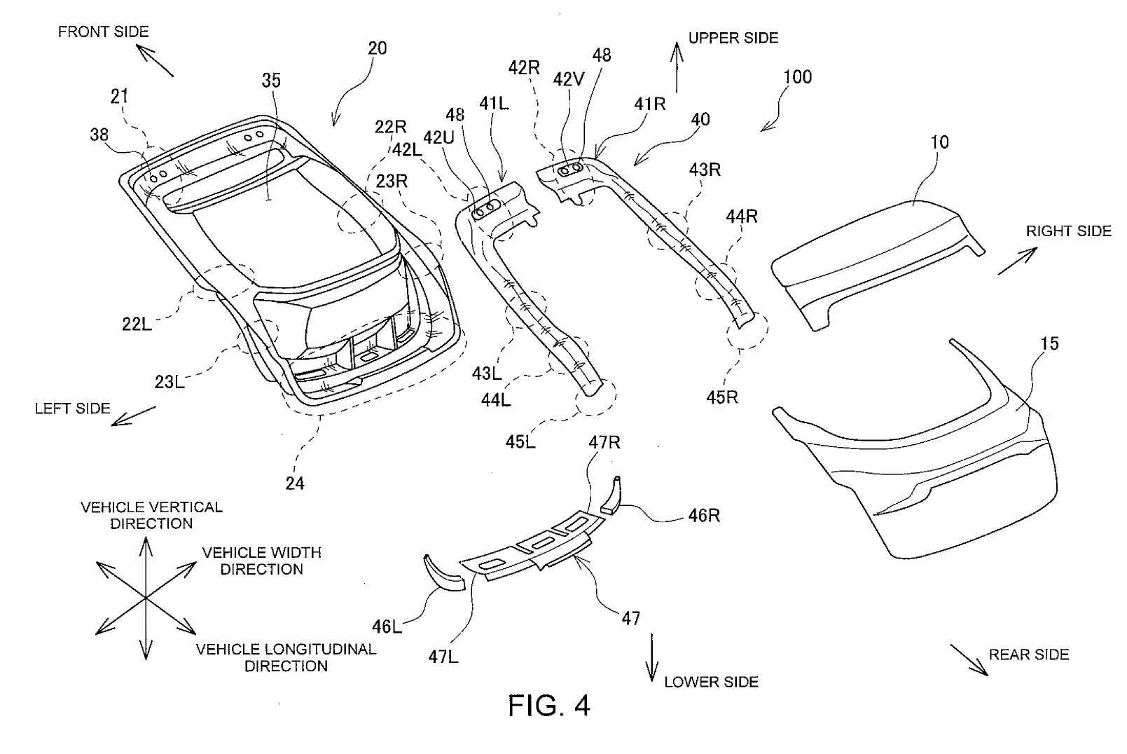

The resin back door 100 includes a resin upper outer panel 10 and a lower outer panel 15, as illustrated in FIG. 3, and the resin inner panel 20 and a metal reinforcing member 40 fixed to the inner panel 20, as illustrated in FIG. 4. The reinforcing member 40 includes a left reinforcing member 41L, a right reinforcing member 41R, a lower-side reinforcing member 47, a left corner connecting member 46L, and a right corner connecting member 46R.

As illustrated in FIG. 4, the inner panel 20 has an upper side portion 21, a left window frame portion 22L and a right window frame portion 22R, a lower left portion 23L and a lower right portion 23R, and a lower side portion 24. The upper side portion 21 has a back window opening 35 which is defined in the center and to which the upper outer panel 10 is assembled above the back window opening 35. The left window frame portion 22L and a right window frame portion 22R are positioned on the outer sides of the back window opening 35 in a vehicle width direction. The lower left portion 23L and the lower right portion 23R are positioned below the back window opening 35 on the outer sides in a vehicle width direction to receive the lower outer panel 15 assembled. On both right and left sides of the upper side portion 21 of the inner panel 20, bolt holes 38 are provided to attach the hinges 75.

The left reinforcing member 41L has a closed-section structure having a substantially L shape along the upper side portion 21, the left window frame portion 22L, and the lower left portion 23L of the inner panel 20. The right reinforcing member 41R has a closed-section structure having a substantially L shape along the upper side portion 21, the right window frame portion 22R, and the lower right portion 23R of the inner panel 20. The left reinforcing member 41L includes an upper left shoulder portion 42L, and an upper left arm portion 43L and a lower left arm portion 44L. The upper left shoulder portion 42L is assembled to be opposed to the upper side portion 21 of the inner panel 20. The upper left arm portion 43L and the lower left arm portion 44L are assembled to be opposed to the left window frame portion 22L and the lower left portion 23L of the inner panel 20, respectively, to extend in a vehicle vertical direction. The upper left shoulder portion 42L has an upper side provided with a recessed portion 42U, and the recessed portion 42U has bolt holes 48 for attaching a hinge.

The right reinforcing member 41R is symmetrical to the left reinforcing member 41L, and includes an upper right shoulder portion 42R, and an upper right arm portion 43R and a lower right arm portion 44R, and the upper right shoulder portion 42R has an upper side provided with a recessed portion 42V in which bolt holes 48 are provided.

The left corner connecting member 46L is a member having a substantially L shape to connect a lower end portion 45L of the left reinforcing member 41L and a left end 47L of the lower-side reinforcing member 47. The right corner connecting member 46R is a member having a substantially L shape to connect a lower end portion 45R of the right reinforcing member 41R and a right end 47R of the lower-side reinforcing member 47.

In the resin back door 100, bolts are inserted through the bolt holes 38 of the inner panel 20 and the bolt holes 48 in both of the left reinforcing member 41L and the right reinforcing member 41R, and nuts are fastened from the opposite side. Thus, the resin back door 100 is fastened to the hinges 75 fixed to right and left sides of the roof panel 13.

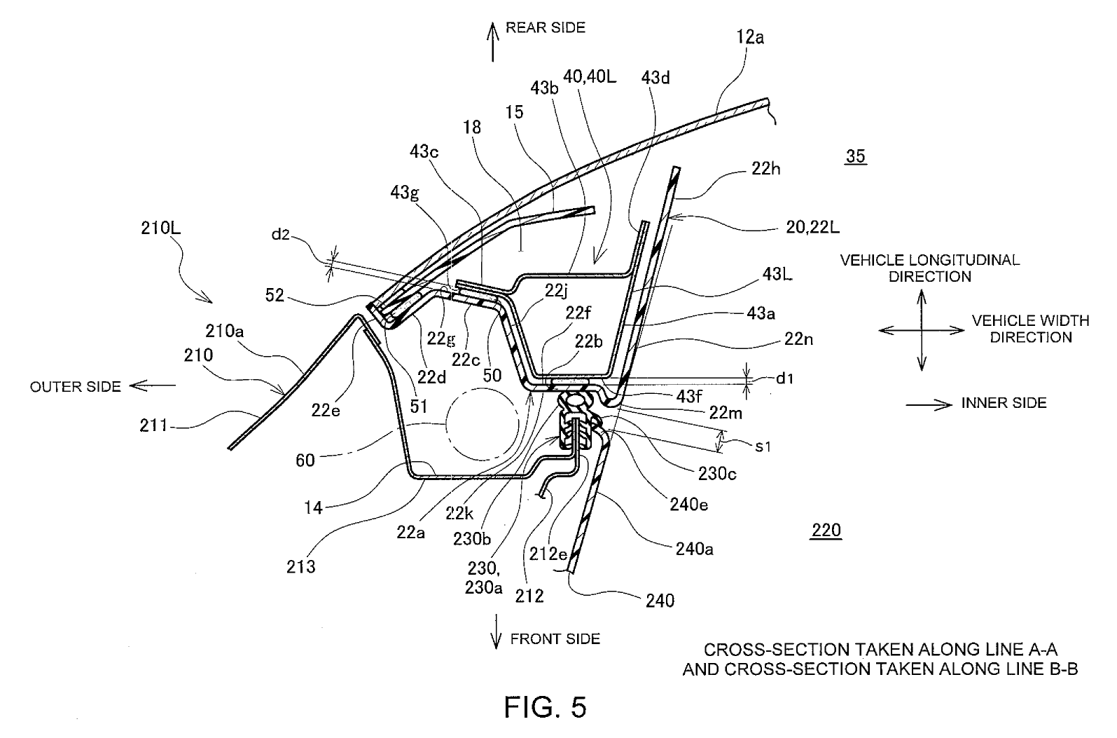

As illustrated in FIG. 5, the upper left arm portion 43L of the left reinforcing member 41L, the upper portion of the lower outer panel 15, and a back window glass 12a are assembled to the left window frame portion 22L of the inner panel 20.

The left window frame portion 22L of the inner panel 20 includes a groove portion 22a, an inner flange 22c, and an outer flange 22d. The groove portion 22a has a substantially groove-shaped cross-section of substantially U shape recessed to the front side in a vehicle longitudinal direction. The groove portion 22a includes a bottom portion 22b on the front side in a vehicle longitudinal direction, an inner vertical wall 22h on the inner side in a vehicle width direction, and an outer vertical wall 22j on the outer side in a vehicle width direction.

The bottom portion 22b includes a bottom surface 22k and a projecting portion 22m. The bottom surface 22k is positioned on the front side in a vehicle longitudinal direction and abuts on the water-tight rubber 230 attached to the peripheral edge of the door opening 220 of the body rear end portion 210. The projecting portion 22m projects toward the door opening 220 at an inner end in a vehicle width direction. The inner vertical wall 22h on the inner side in a vehicle width direction of the groove portion 22a is connected to the projecting portion 22m of the bottom portion 22b and extends to the rear side in a vehicle longitudinal direction. The outer vertical wall 22j on the outer side in a vehicle width direction of the groove portion 22a extends to the rear side from the bottom portion 22b in a vehicle longitudinal direction to be connected to the inner flange 22c. The inner flange 22c bends and extends to the outer side in a vehicle width direction, from a rear end of the outer vertical wall 22j of the bottom portion 22b positioned in a vehicle longitudinal direction, and is connected to the outer flange 22d extending to the outer side in a vehicle width direction. An outer side of the outer flange 22d in a vehicle width direction is formed as a parting portion 22e positioned on the outer side in a vehicle width direction of the inner panel 20.

An upper portion of the lower outer panel 15 has an outer portion in a vehicle width direction assembled to the outer flange 22d of the left window frame portion 22L of the inner panel 20 with an adhesive 51 at a strip-shaped portion projecting upward on the outer side in a vehicle width direction, and an inner side portion in a vehicle width direction extends to the inner side in a vehicle width direction to cover the groove portion 22a of the inner panel 20. A hollow space 18 is formed between the upper portion of the lower outer panel 15 and the groove portion 22a of the inner panel 20, and the upper left arm portion 43L of the left reinforcing member 41L is disposed in the hollow space 18.

The upper left arm portion 43L of the left reinforcing member 41L has a substantially square annular closed-section structure, and includes collar portions 43c and 43d projecting to the outer side in a vehicle width direction and to the rear side in a vehicle longitudinal direction, respectively. The upper left arm portion 43L of the left reinforcing member 41L includes an inner plate 43a and an outer plate 43b. The inner plate 43a is positioned near the inner panel 20 and includes collars having a substantially U shape extending to the outer side in a vehicle width direction and to the rear side in the vehicle longitudinal direction, and the outer plate 43b has a bending plate formed to close an opening side of the inner plate 43a of U-shape and includes collars on both sides to be assembled to the collars of the inner plate 43a. Joint portions between the collars of the inner plate 43a and the collars of the outer plate 43b constitute the collar portions 43c and 43d, respectively. A surface 43f of a bottom portion of the inner plate 43a of the left reinforcing member 41L is arranged to a surface 22f of the groove portion 22a of the inner panel 20 leaving a gap d1 and is fixed thereto with an adhesive 50. A surface 43g of the collar portion 43c of the left reinforcing member 41L near the inner panel 20 is arranged at a surface 22g of the inner flange 22c of the inner panel 20 leaving a gap d2 and is fixed thereto with an adhesive 50. The outer plate 43b and the upper part of the lower outer panel 15 are separated from each other. The lower outer panel 15 is assembled onto the outer flange 22d of the inner panel 20 via a urethane material 52, and the back window glass 12a is attached onto the rear side of the upper portion of the lower outer panel 15 in a vehicle longitudinal direction.

As illustrated in FIG. 5, when the door opening 220 is closed by the resin back door 100, the bottom surface 22k of the bottom portion 22b of the inner panel 20 presses the packing portion 230b of the water-tight rubber 230 against the collar portion 212e at the peripheral edge of the door opening 220. Furthermore, an end of the projecting portion 22m of the bottom portion 22b on the side of the door opening 220 extends toward the door opening 220 to a position overlapping the packing portion 230b in a vehicle width direction. A gap between the end of the projecting portion 22m and the end portion 240e of the inner garnish 240 on the rear side of the vehicle decreases to s1.

Furthermore, a design surface 22n of the inner vertical wall 22h on the inner side in a vehicle width direction is substantially flush with the design surface 240a of the inner garnish 240 on the inner side in a vehicle width direction or on the interior side, where the inner garnish 240 constitutes the design surface of the inner periphery of the door opening 220.

As described above, when the door opening 220 is closed by the resin back door 100, the gap between the end of the projecting portion 22m of the bottom portion 22b of the inner panel 20 and the end portion 240e of the inner garnish 240 on the rear side of the vehicle decreases. Thus, the water-tight rubber 230 is concealed when viewing the rear side of the vehicle from the interior, and the appearance of the rear side of the vehicle when viewed from the interior can be improved. Furthermore, the design surface 22n of the inner vertical wall 22h on the inner side in a vehicle width direction is substantially flush with the design surface 240a of the inner garnish 240 as an interior trim surface on the inner side in a vehicle width direction or on the interior side so that the design surface 22n of the inner panel 20 on the inner side in a vehicle width direction constitutes an integrated design surface extending to the design surface 240a in the door opening 220 on the inner side in a vehicle width direction. Thus, the configuration provides an integrated design of the interior inner surface and improvement in the appearance.

1. A resin back door for a vehicle for opening and closing a door opening at a body rear end portion, the resin back door comprising
a resin inner panel including a window frame portion for a back window opening positioned on an outer side in a vehicle width direction,
wherein the window frame portion of the inner panel has a substantially groove-shaped cross-section, and includes a bottom portion abutting on a water-tight rubber attached to a peripheral edge of the door opening, and an inner vertical wall positioned on an inner side in a vehicle width direction to be connected to the bottom portion,
the bottom portion has a projecting portion projecting toward the door opening at an inner end in a vehicle width direction, and
when the door opening is closed, a surface of the inner vertical wall on an inner side in a vehicle width direction is substantially flush with an interior trim surface attached to an inner periphery of the door opening.
